(19) United States
(12) Patent Application Publication
(10) Pub. No.: US 2025/0091287 A1
(43) Pub. Date: Mar. 20, 2025

(54) METHODS FOR MANUFACTURING GUITAR PICKS

(71) Applicants: Marc Silverberg, Lafayette, CA (US); Andrew Soderberg, San Marcos, CA (US)

(72) Inventors: Marc Silverberg, Lafayette, CA (US); Andrew Soderberg, San Marcos, CA (US)

(21) Appl. No.: 18/890,256

(22) Filed: Sep. 19, 2024

Related U.S. Application Data
(60) Provisional application No. 63/539,350, filed on Sep. 20, 2023.

(51) Int. Cl. B29C 64/118; B29C 37/00; B29C 64/182; B29C 64/245; B29C 64/295; B29C 64/364; B29C 64/386; B29L 31/00; B33Y 10/00; B33Y 30/00; B33Y 40/20; B33Y 50/00; B33Y 80/00

(52) U.S. Cl. CPC B29C 64/118; B29C 37/0025; B29C 64/182; B29C 64/245; B29C 64/295; B29C 64/364; B29C 64/386; B33Y 10/00; B33Y 30/00; B33Y 40/20; B33Y 50/00; B33Y 80/00; B29L 2031/758

(57) ABSTRACT

A method of manufacturing a pick, includes determining a printing file, the printing file including a layout for printing a plurality of picks on a printing plate. The method includes printing the plurality of picks on the printing plate. The printing plate includes textured sections and the layout of the printing file causes a top portion of each pick of the plurality of picks to be printed on one of the textured sections.

### CROSS-REFERENCE TO RELATED APPLICATIONS

This application claims the benefit of priority of U.S. provisional application No. 63/539,350, filed Sep. 20, 2023, titled “GUITAR PICK” the entire contents of which are herein incorporated by reference.

### FIELD

The present disclosure relates to guitar picks and methods for manufacturing the same.

### BACKGROUND

A guitar pick is a tool used to play stringed instruments, for example, guitars. Picks are generally made of one uniform material, such as plastic, rubber, wood, metal, etc. Conventionally, picks are usually triangular in shape with the two equal corners rounded and the third corner equal or less rounded. Picks can used to strum chords or to sound individual notes on a guitar. Conventional picks, however, may not be optimized for all playing styles and conditions.

As can be seen, there is a need for improved picks that address the drawbacks of conventional picks.

### SUMMARY

In one aspect of the present disclosure, a method of manufacturing a pick, includes determining a printing file, the printing file including a layout for printing a plurality of picks on a printing plate. The method includes printing the plurality of picks on the printing plate. The printing plate includes textured sections and the layout of the printing file causes a top portion of each pick of the plurality of picks to be printed on one of the textured sections.

In another aspect of the present disclosure, a method of manufacturing a pick includes determining a printing file, the printing file including a layout for printing a plurality of picks on a printing plate. The method includes printing the plurality of picks on the printing plate. Printing the plurality of picks on the printing plate includes depositing a plurality of filament lines, wherein one or more of the filament lines varies in at least one of height or width in predetermined portions of the plurality of picks.

In another aspect of the present disclosure, a method of manufacturing a pick includes determining a printing file, the printing file including a layout for printing a plurality of picks on a printing plate. The method includes printing the plurality of picks on the printing plate. Printing the plurality of picks on the printing plate includes depositing a plurality of filament lines at a flow rate and print speed, wherein at least one of flow rate and print speed varies in predetermined portions of the plurality of picks.

In another aspect of the present disclosure, a method of manufacturing a pick includes determining a printing file, the printing file including a layout for printing a plurality of picks on a printing plate. The method includes printing the plurality of picks on the printing plate. Printing the plurality of picks on the printing plate includes printing each of the plurality of picks to include at least one recess in a surface of the pick, and filling the at least one recess with one or more layers to form at least one graphic, wherein at least one graphic is substantially flat with a plane the surface of the pick or raised above the plane of the surface of the pick.

In another aspect of the present disclosure, a method of manufacturing a pick includes determining a printing file, the printing file including a layout for printing a plurality of picks on a printing plate. The method includes printing the plurality of picks on the printing plate. The method includes sanding a playing portion of each of the plurality of picks after printing.

In another aspect of the present disclosure, a method of manufacturing a pick includes determining a printing file, the printing file including a layout for printing a plurality of picks on a printing plate. The method also includes heating at least one of: a portion of the printing plate to a first temperature ranging between approximately 60 degrees Celsius and approximately 120 degrees, and heating a chamber containing the printing plate to a second temperature ranging between 60 degrees Celsius and approximately 80 degrees Celsius while printing the plurality of picks. The method includes printing the plurality of picks on the printing plate.

### BRIEF DESCRIPTION OF THE DRAWINGS

FIGS. 1A-1E are various views of a first example of a pick with a first example of a fin, according to aspects of the present disclosure;

FIGS. 2A-2C are various views of the first example of a pick with a second example of a fin, according to aspects of the present disclosure;

FIG. 3 is a perspective view of the first example of a pick with a third example of a fin, according to aspects of the present disclosure;

FIG. 4 is a perspective view of the first example of a pick with a fourth example of a fin, according to aspects of the present disclosure;

FIGS. 5A-5F are various views of a second example of a pick with a first example of a fin, according to aspects of the present disclosure;

FIGS. 6A-6E are various views of a third example of a pick with a first example of a fin, according to aspects of the present disclosure;

FIG. 7 is an elevated view of a fourth example of a pick with a first example of a fin, according to aspects of the present disclosure; and

FIG. 8 is a flow diagram of a process for manufacturing a pick, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims. There is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

As discussed above, a user may typically grip a guitar pick at or just below the gripping edge of the guitar pick and hit a string or many strings with the tip of the guitar pick. Conventional picks, however, may shift or drop from the user's grip while playing.

Broadly, an embodiment of the present disclosure provides various picks designed to address these issues for improved comfort and control while strumming and picking. According to various embodiments, the picks can include a main or pick body that is essentially planer or flat and incorporates one or more of the following features: one or more fins extending from the picks, a playing portion that is wider than a conventional curved, pointed tip, and/or an off-center playing portion. As used herein, a “playing portion,” refers to lower portions of the pick that makes contact with stings of an instrument during playing and can include a “tip” or “tip side.”.

In embodiments, a gripping, top edge/side, and/or other edge/side of a pick can include at least one fin (also referred to as a “gripping edge tab” or “winged tab”) which extends outwardly from a top surface of the main body. This fin forms a wall in a 3rd dimension in which the inner part of the thumb and/or the index finger can rest, and/or grip. This stops the player's thumb or index finger from moving and provides an improved grip, resulting in more precision and less pick shifting over longer time periods. In certain embodiments, the main body may include various indentations and/or etched patterns, textures, and the like. In some embodiments, the pick can include a fin positioned on a top side of the pick. In some embodiments, the pick may comprise a centered pointed playing portion (“tip”) and a side-shifted fin at or near a corner of the pick and/or one or more sides of the pick.

In embodiments, the pick can be manufactured using three-dimensional (3D) printing processes. The process can include printing at least a partially textured surface on the pick. The process can also include sanding the tip of the pick to remove imperfections.

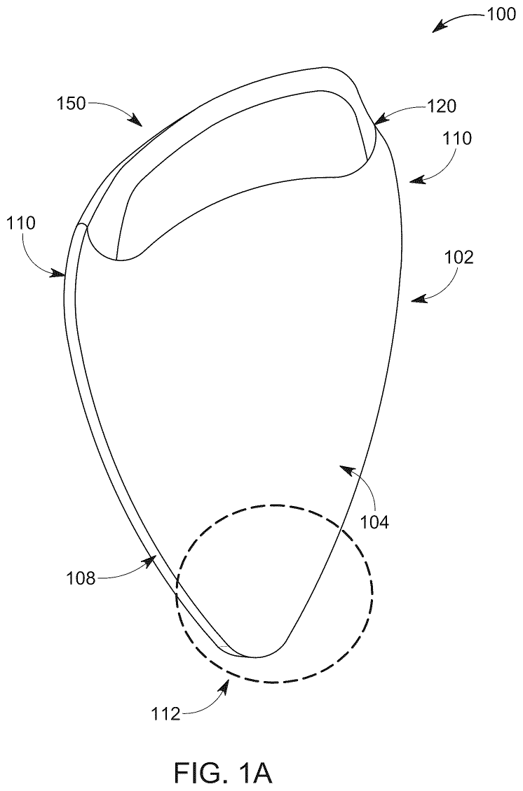

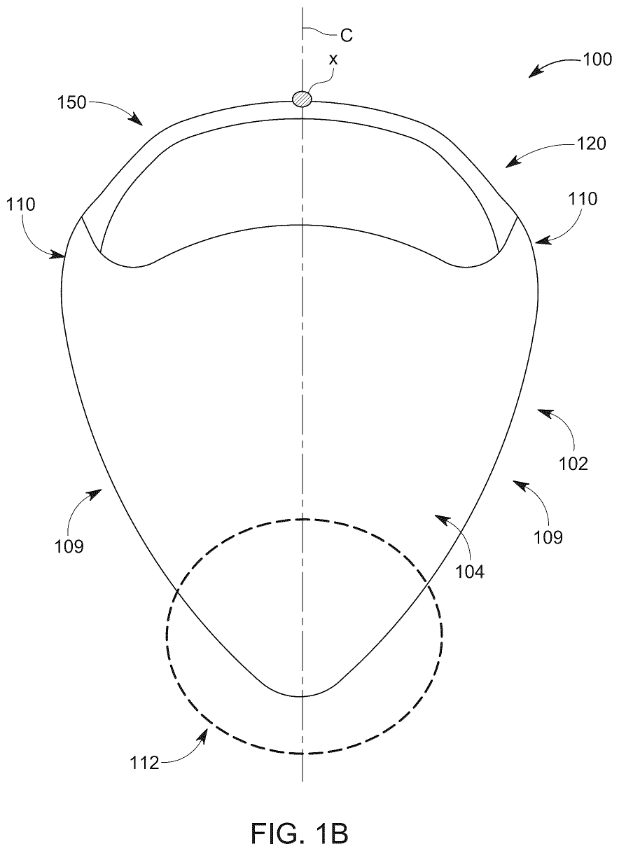

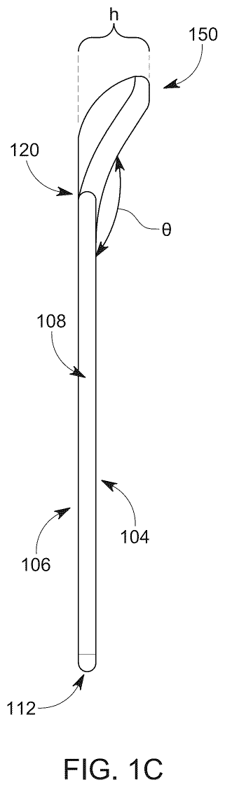

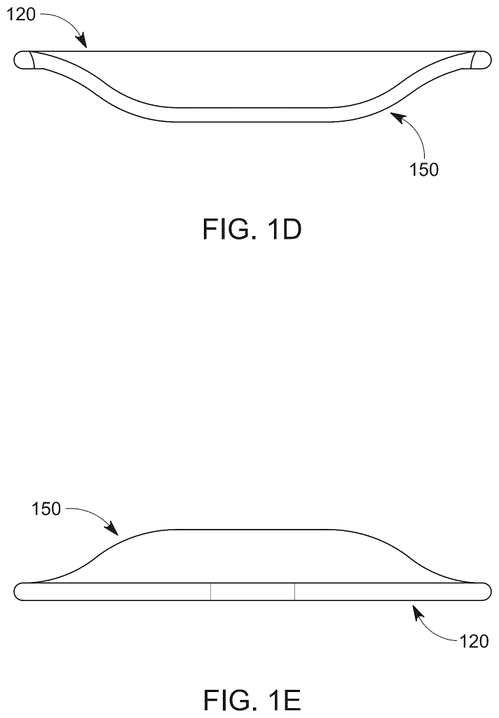

Referring now to Figures, FIGS. 1A-1E illustrate a pick 100, according to aspects of the present disclosure. While FIGS. 1A-1E illustrate examples of components of the pick 100, additional components can be added and existing components can be removed and/or modified.

As illustrated in FIG. 1A (perspective view) and FIG. 1B (front elevated view), the pick 100 includes a pick body 102 and at least one fin 150. The fin 150 operates to provide a surface that extends outwardly from a surface of the pick body 102. The fin 150 forms a wall, ramp, rest, or stop that engages with an inner part of a thumb and/or an index finger of a user. When using the pick 100, the fin 150 inhibits the user's thumb or index finger from moving and provides an improved grip, resulting in more precision and less pick shifting over longer time periods. As such, it shall be appreciated that the term “essentially planer or flat” should not be construed as limiting the main body to a smooth surface.

The pick body 102 is formed having a front surface 104, a back surface 106 opposite the front surface 104, and a side surface 108 formed around a perimeter of the pick body 102 between the front surface 104 and the back surface 106. In some embodiments, the side surface 108 (e.g., front surface 104 and back surface 106) is formed in the shape of an acute isosceles triangle with a top side 120 and two lateral sides 109 coupled to the top side at two equal corners 110, which can be rounded. The two lateral sides 109 converge to form a “tip” with the playing portion 112. The playing portion 112 forms a primary surface/edge of the pick body 102, which is intended to make contact with the strings of an instrument. In this example, the playing portion 112 can include a rounded tip that is formed at the intersection of the lateral sides 109. In embodiments, as illustrated in FIG. 1B, the pick body 102 can be symmetrical about a center line, C, which extends perpendicular to a center point, X, of the top side 120.

In embodiments, the pick 100 includes at least one fin 150 extending from the front surface 104 adjacent to the gripping edge 120. The fin 150 extends from the front surface 104 at an angle relative to a plane of the front surface 104, as illustrated in FIGS. 1C (side elevation view), 1D (top elevation view), and 1E (bottom elevation view). As illustrated in FIG. 1C, the fin 150 can be cantered (tilted or angled) at an angle, θ, relative to the front surface 104 of the pick body 102. For example, the angle, θ, can range between approximately 90.0 degrees and 170.0 degrees, preferably 130.0 degrees to 165.0 degrees. The fin 150 can extend from the front surface 104 at a height, h, to form a wall, ramp, rest, or stop that engages with an inner part of a thumb and/or an index finger of a user. For example, the height, h, can range between approximately 3.0 millimeters and 12.0 millimeters, for example, approximately 4.0 millimeters. While examples of the height and angle are described above, these are merely examples of ranges, the fin can have any height and/or angle that provides a stop or wall during use of the pick.

In some embodiments, the fin 150 can extend in only one direction (e.g., frontwards) from the front surface 104 of the pick body 102. In some embodiments, the fin 150 can extend both frontwards and rearwards from the front surface 104 of the pick body 102. In some embodiments, the fin 150 can include ribs (or other structures) 152. For example, the ribs 152 can be formed as small, raised strips which are added to the fin 150 for structural strength and a texture surface to assist gripping.

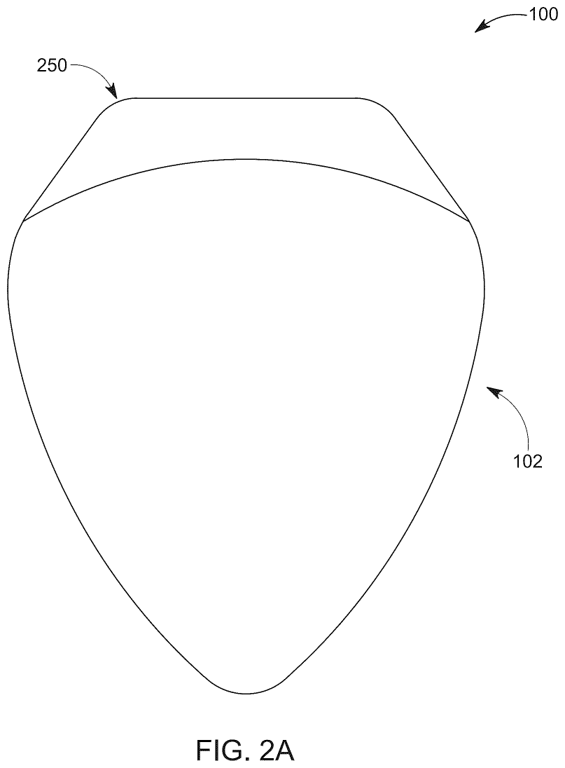

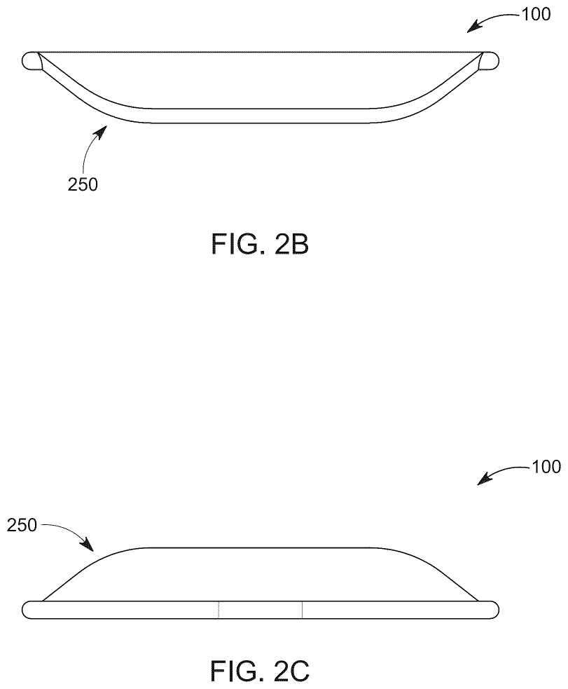

As illustrated in FIGS. 1D and 1E, the fin can include a base adjacent to the front surface 104 of the pick body and sides that extend to a top of the fin. The fin 150 can have an elongated pyramid shape, having an approximate trapezoidal cross-sectional shape with around corners. That is, the base of the fin 150, which contacts the front surface 104 of the pick body 102, can be larger than a top (proximal to the base) of the fin 150. In some embodiments, the fin 150 can be curved matching a curve of the side surface 108 at the gripping surface 120. As illustrated in FIGS. 1A and 1B, the fin 150 can have a curved top edge. In some embodiments, as illustrated in FIG. 2A-2C, the pick 100 can include a fin 250 that has an approximately flat top edge.

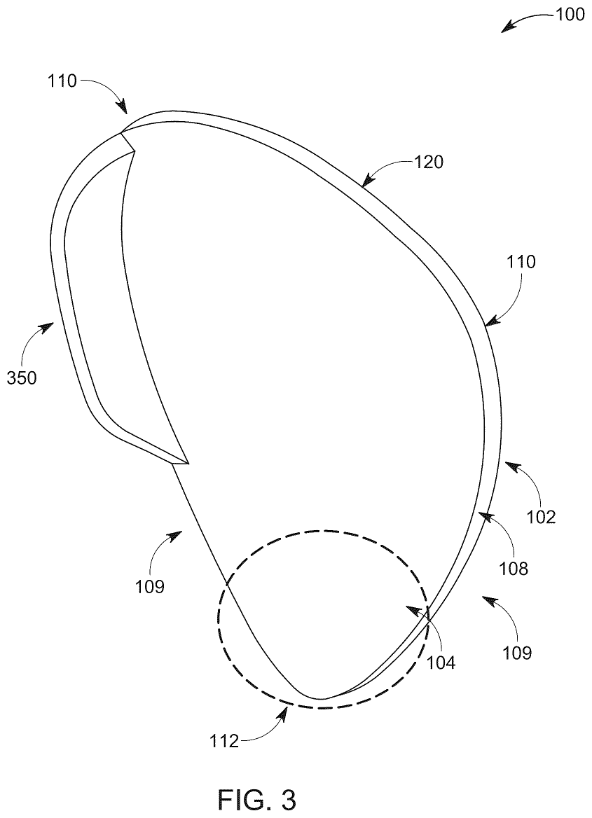

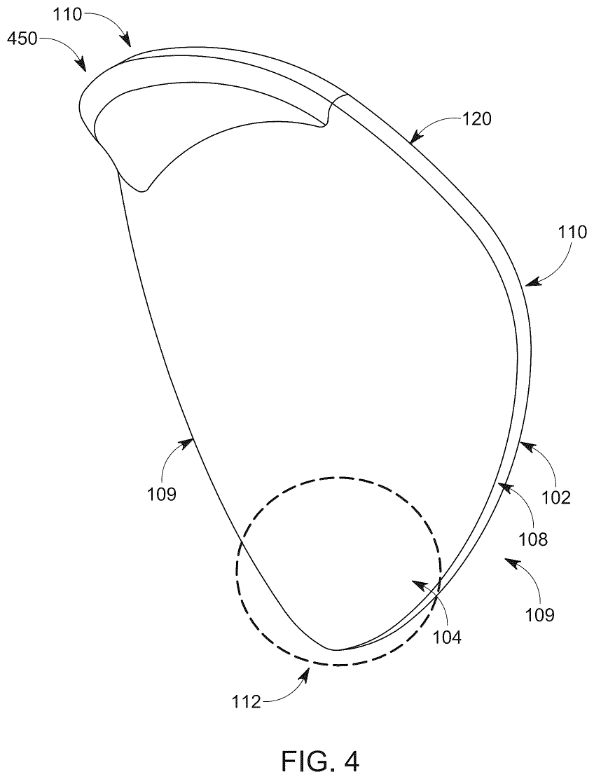

As illustrated in FIGS. 1A-1E, the fin 150 can be disposed adjacent to the top side 120 of the pick body 102. In other embodiments as shown in FIGS. 3, the pick 100 can include one or more fins 350 that be shifted to one or more of the lateral sides 109 of the pick body 102. As illustrated, the fin 350 can be positioned adjacent to on between the corner 110 and the playing portion 112. For example, the fin 350 can extend from the corner 110 along an edge of the front surface 104 towards the playing portion 112. In one example, the fin 350 can extend from the corner 110 approximately 50 percent of the distance along the lateral side 109 of the front surface 104 towards the playing portion 112. While FIG. 3 illustrates the fin 350 being positioned on a left lateral side 109 of the pick body 102, the fin 350 can be positioned on at the right lateral side 109 of the pick body 102. While FIG. 3 illustrates one fin 350, the pick 100 can include two fins, where each fin 350 is positioned on opposing sides of the pick body 104.

In some embodiments, as illustrated in FIG. 4, the pick can include a fin 450 that may cover at least a portion of both the top edge and the side edge of the main body. As illustrated, the fin 450 can be formed at one of the corners 110 of the pick body 102. In embodiments, the fin 450 can curve around the perimeter of one of the corners 110. While FIG. 4 illustrates the fin 450 is positioned on a left former 110, the fin 450 can be positioned on the right corner 110 or can be positioned on both corners 110.

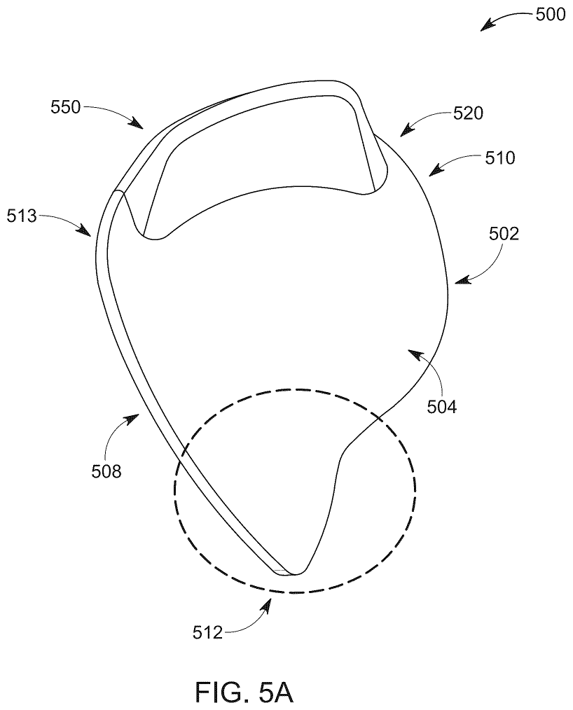

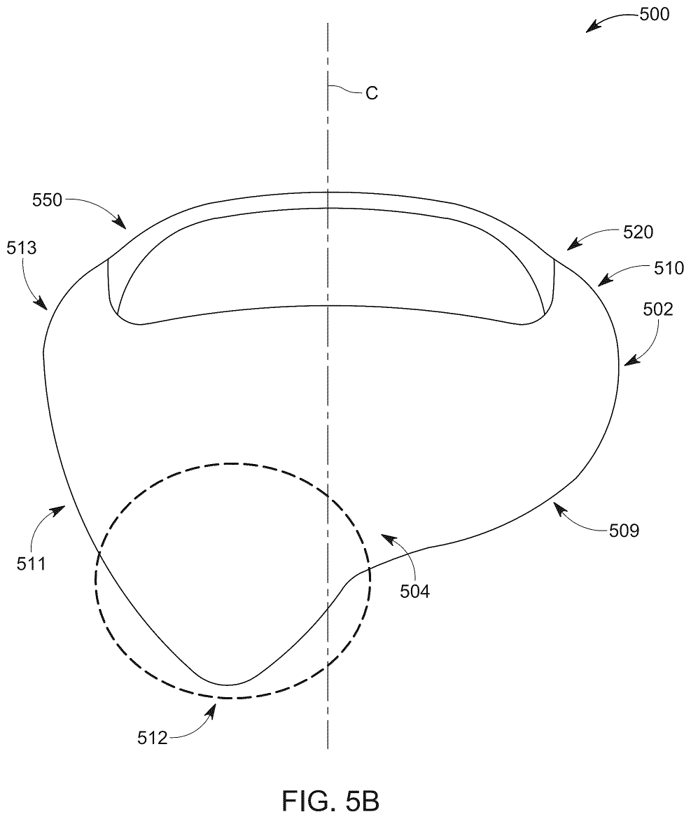

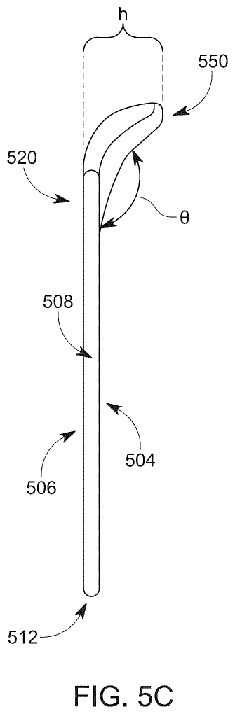

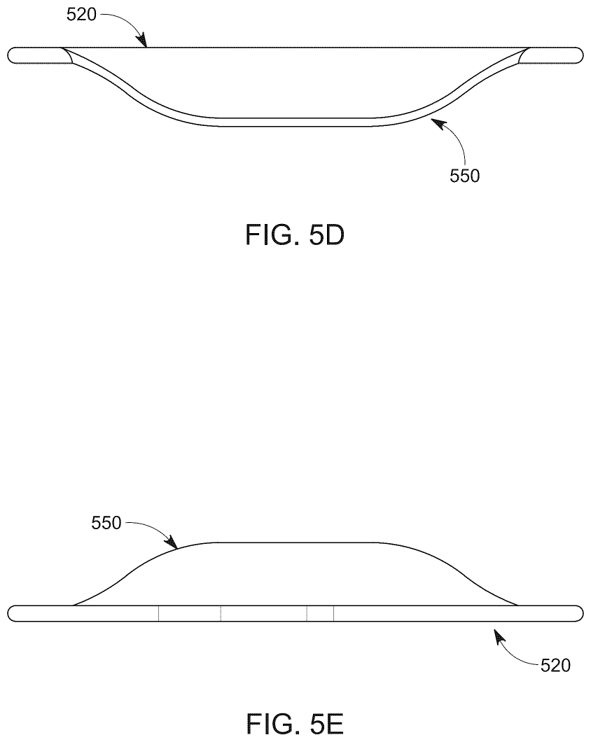

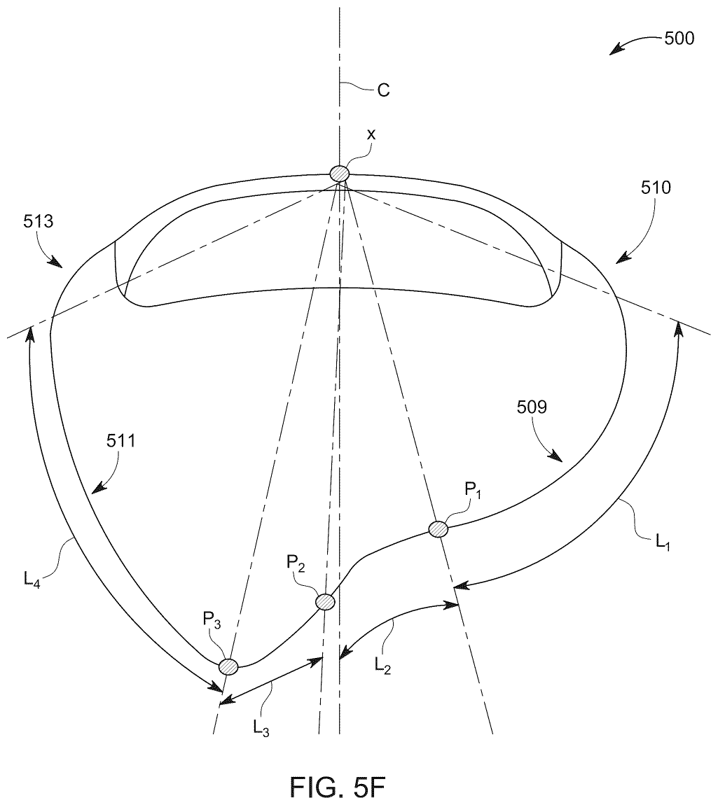

FIGS. 5A-5E illustrate a pick 500 that includes a playing portion that may be an off-center edge which is skewed to the left or right with respect to a top side, and provides an asymmetric shape in the main body. While FIGS. 5A-5E illustrate examples of components of the pick 500, additional components can be added and existing components can be removed and/or modified.

As illustrated in FIG. 5A (perspective view) and FIG. 5B (front elevated view), the pick 500 includes a pick body 502. The pick body 502 is formed having a front surface 504, a back surface 506 opposite the front surface 504, and a side surface 508 formed around a perimeter of the pick body 502 between the front surface 504 and the back surface 506. As illustrated in FIG. 5B, the pick body 502 is formed having an asymmetric shape about a center line, C, which extends perpendicular to a center point of a top side 520. The pick body 502 is formed, having the top side 520 and a first lateral side 509 coupled to a first corner 510, and a second lateral side 511 coupled to a second corner 513. As illustrated in FIG. 5F, the first lateral side 509, starting at the first corner 510, curves in a first direction (positive curvature or “convex”) with a first degree of curvature, L₁. From point P1 until point P2, the first lateral side 509 changes curvature to a second direction (negative curvature or “concave”) with a second degree of curvature, L₂. At point P2, the first lateral side 509 changes curvature to the first direction (positive or “convex”) with a third degree of curvature, L₃, until a point, P₃, e.g., the “tip.” The second lateral side 511 curves in a third direction (positive curvature or “convex”) with a fourth degree of curvature, L₄, until a point, P₃, e.g., the “tip,” the point at which the first lateral side 509 and the second lateral side 511 converge.

In embodiments, the first degree of curvature of the first lateral side 509 can be greater than the fourth degree of curvature of the second lateral side 511. Additionally, the length of the first lateral side 509 can be greater than the length of the second lateral side 511, thereby causing the “tip” and the playing portion 512 to be shifted or offset relative to the center-line, C. In this example, the playing portion 112 can include a rounded tip. That is, the playing portion 512 is not positioned directly opposing the gripping surface 520. For example, as illustrated in FIG. 5B, when viewed from the front, the playing portion 512 can be shifted to the left side of the pick body 502. In other embodiments, when viewed from the front, the playing portion 512 can be shifted to the right side of the pick body 502. The playing portion 512, which is shifted off-center, allows the thumb to be placed closer to the strings when comfortably holding the main body of the pick, allowing for more precise use of the pick 500, e.g., picking, and improved accuracy for certain instruments such as bass guitarists and/or style of guitar play.

In some embodiments, the pick 500 includes a fin 550. The fin 550 extends from the front surface 504 at an angle relative to a plane of the front surface 504, as illustrated in FIGS. 5C (side elevation view), 5D (top elevation view), and 5E (bottom elevation view). As illustrated in FIG. 5C, the fin 550 can be cantered (tilted or angled) at an angle, θ, relative to the front surface 504 of the pick body 502. For example, the angle, θ, can range between approximately 90.0 degrees and 170.0 degrees, preferably 130.0 degrees to 165.0 degrees. The fin 550 can extend from the front surface 504 at a height, h, to form a wall, ramp, rest, or stop that engages with an inner part of a thumb and/or an index finger of a user. For example, the height, h, can range between approximately 3.0 millimeters and 12.0 millimeters, for example, approximately 4.0 millimeters. While examples of the height and angle are described above, these are merely examples of ranges, the fin can have any height and/or angle that provides a stop or wall during use of the pick.

As illustrated in FIGS. 5D and 5E, the fin 550 can have an approximate trapezoidal cross-sectional shape with around corners, as discussed above with reference to fin 150. While FIGS. 5A-5E illustrate a fin 550, in some embodiments, the fin 550 can be omitted from the pick 500.

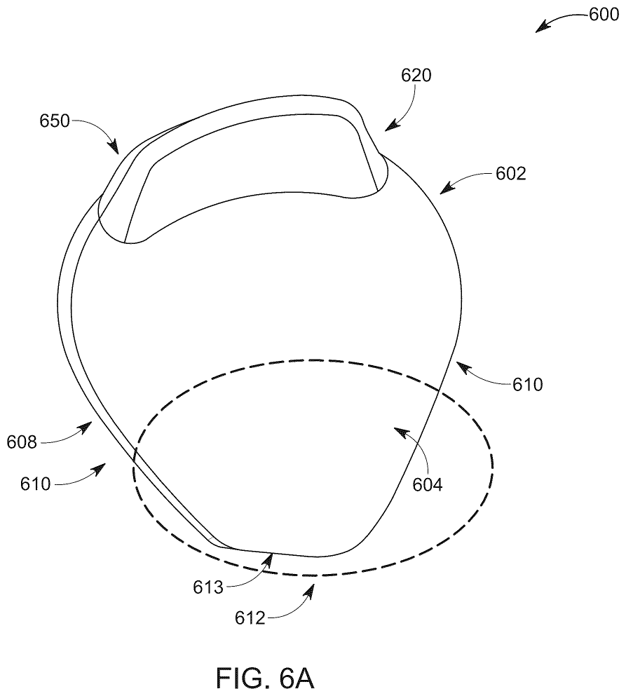

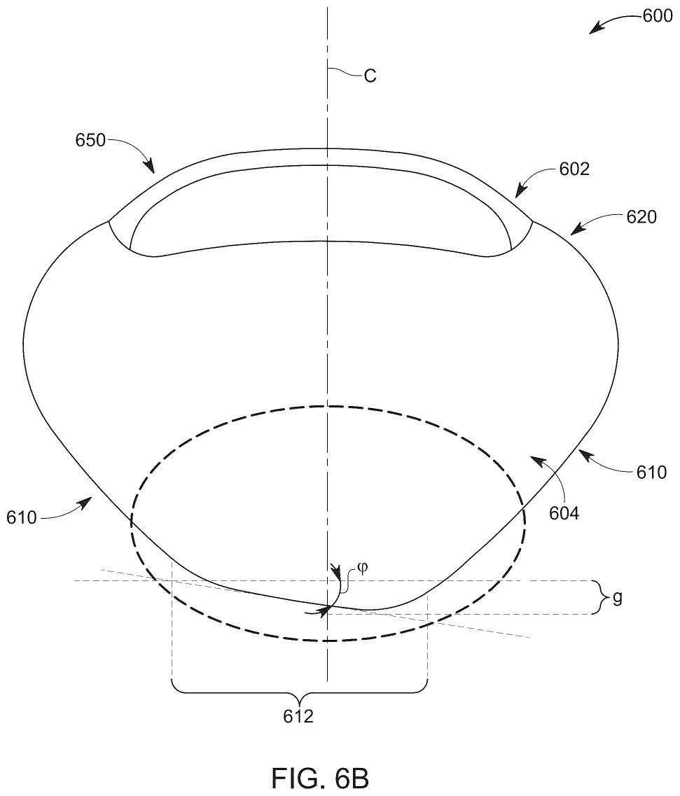

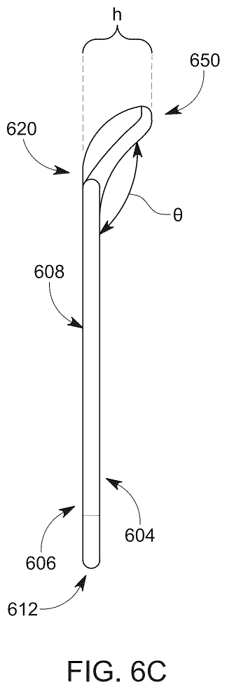

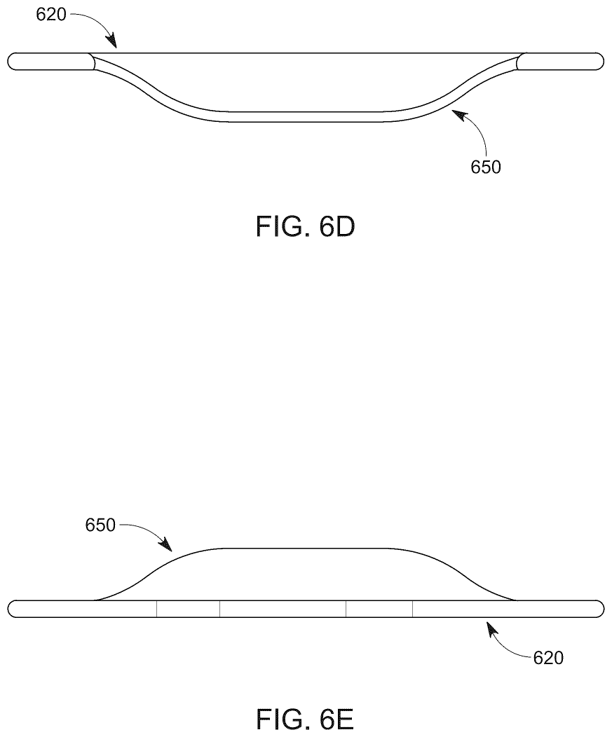

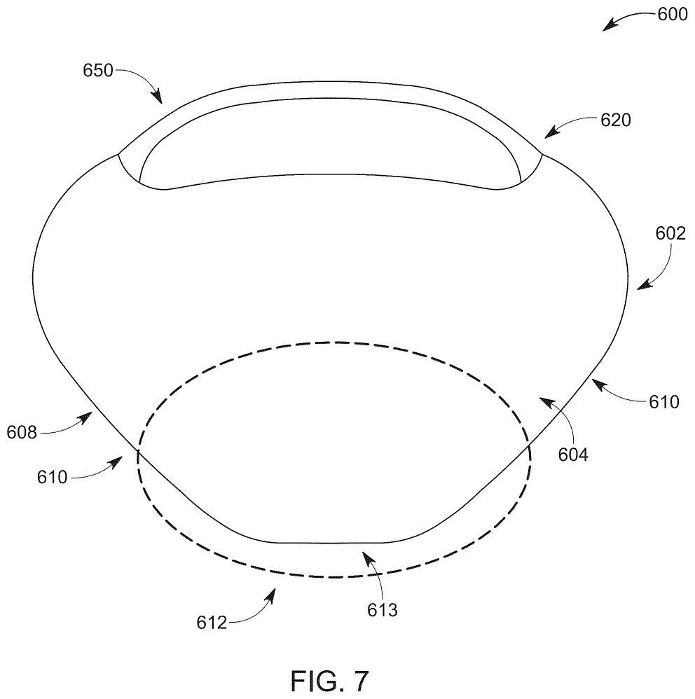

In embodiments, the tip of the pick can be a pointed edge, for example, as illustrated in FIGS. 1A-1E. In other embodiments, the tip may be flat and form one of the sides of the pick. FIGS. 6A-6E and FIG. 7 illustrate a pick 600 that includes a flat or approximately flat tip, according to aspects of the present disclosure. While FIGS. 6A-6E illustrate examples of components of the pick 600, additional components can be added and existing components can be removed and/or modified.

As illustrated in FIG. 6A (perspective view) and FIG. 6B (front elevated view), the pick 600 includes a pick body 602. The pick body 602 is formed having a front surface 604, a back surface 606 opposite the front surface 604, and a side surface 608 formed around a perimeter of the pick body 602 between the front surface 604 and the back surface 606. The pick body 602 can be shaped having four sides: a top side 620, and two lateral sides 610 running between the top side 620 and a bottom side 613, which opposes the top side 620. The bottom side 613 is formed within a playing portion 612 of the pick body 602. In some embodiments, the two lateral sides 610 are angled such that the top side 620 is wider than the bottom side 613. For example, the two lateral sides 610 can be coupled to opposing ends of the top side 620 at angles less than 90.0 degrees.

In embodiments, the playing portion 612 operates as the primary edge, side, and/or point that makes contact with the strings of an instrument, with the bottom side 613 operating as the playing edge. In embodiments, the bottom side 613 can be approximately straight (approximately linear) between the connection between the two lateral sides 610. For example, the bottom side 613 can have a curvature or arc (in any or multiple directions) less than about 0.5 mm. In embodiments, the bottom side 613 can be slanted relative to the top side 620. For example, as illustrated in FIG. 6B, the bottom side 613 can be at an angle, ϕ, such that the bottom side 613 has a rise of g from the connection points with the connecting sides 610. In some embodiments, as illustrated in FIG. 7, the bottom side 613 can approximately parallel with the top side 620. While FIG. 6B illustrates the left lateral side 610 being shorter than the right lateral side 610, the right lateral side 610 can be shorter than the left lateral side 610 thereby “flipping” the angle, φ.

In some embodiments, a bottom side 613 may be at least about 6 mm wide between the connection to the two lateral sides 610, with less than about 0.5 mm of arc on the tip, e.g., approximately straight. In some embodiments, the bottom side 613 may be slightly angled relative to the top edge of the pick, as discussed above. In some embodiments, these features may be combined with a main body which is wider than that of a standard pick.

In some embodiments, the pick 600 includes a fin 650. The fin 650 extends from the front surface 604 at an angle relative to a plane of the front surface 604, as illustrated in FIGS. 6C (side elevation view), 6D (top elevation view), and 6E (bottom elevation view). As illustrated in FIG. 6C, the fin 650 can be cantered (tilted or angled) at an angle, θ, relative to the front surface 604 of the pick body 602. For example, the angle, θ, can range between approximately 90.0 degrees and 170.0 degrees, preferably 130.0 degrees to 165.0 degrees. The fin 650 can extend from the front surface 604 at a height, h, to form a wall, ramp, rest, or stop that engages with an inner part of a thumb and/or an index finger of a user. For example, the height, h, can range between approximately 3.0 millimeters and 12.0 millimeters, for example, approximately 4.0 millimeters. While examples of the height and angle are described above, these are merely examples of ranges, the fin can have any height and/or angle that provides a stop or wall during use of the pick.

The playing portion 612 as shown in FIGS. 6A-6E and FIG. 7A address difficulties of prolonged strumming with a pick. Conventional guitar picks may have a planar body with a pointed tip and a flat, rounded, gripping edge opposite the tip. When strumming, the tip's edge typically passes a string before changing direction, and often the tip of the pick may fall below the string. Additionally, added string resistance from changing strum direction requires extra physical force for maintaining a consistent strum. Furthermore, when strumming at high speed (e.g., at the finale of a song), the effort required to change direction may be significantly higher, and as such, many players will find it difficult to continue at a consistent pace after about 20-30 seconds. The playing portion 650 of the pick 600 allows for much less resistance when changing direction of a strum, making a very fast strum much easier and allows a player to strum at their fastest speed in multiple short bursts or for longer continuous fast strum. This is because most players may fail to keep the pick 600 perfectly parallel, causing part of the playing portion 650 to stay on top of the string for a longer part of the strum, and most importantly, when the strum changes direction. This will occur in most strumming direction changes, in which case the playing portion 650 prevents the pick from falling below the string when changing direction, thus significantly reducing friction when changing direction. As such, continuous strumming, and bursts of quick strums are made much easier.

It shall be appreciated that a pick can incorporate any one of the disclosed features, i.e., one or more fins, a tip side for strumming, and an off-center tip alone or in combination. In some embodiments, a pick incorporating one or more of these features may be used to design a pick for different types and/or styles of playing guitar such as strumming and picking. These features may substantially improve grip, picking accuracy, strum control, and/or speed, when playing.

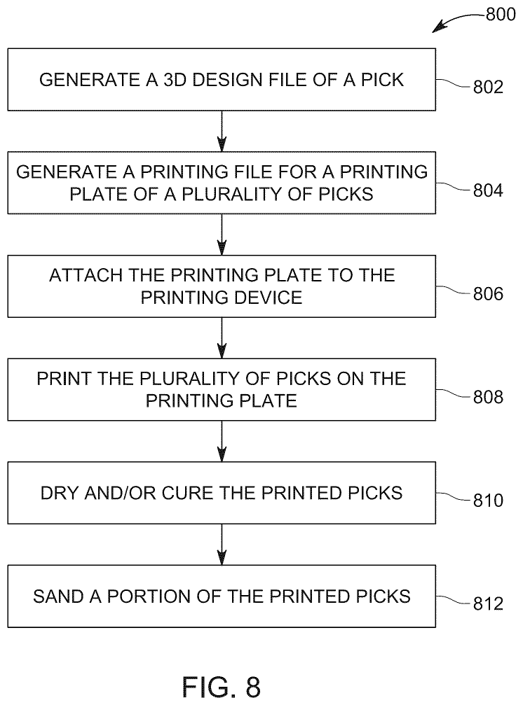

In certain embodiments, the pick may be manufactured using injection molding or 3D printing. It shall be appreciated that the device may be manufactured and assembled using any known techniques in the field. FIG. 8 illustrates a method 800 for manufacturing a pick, according to aspects of the present disclosure. While FIG. 8 illustrates example stages of the method 800, additional stages can be added and existing stages can be reordered or removed.

In stage 802, a 3D design file can be generated for the pick. For example, a 3D model of one or more of the picks can be generated using Computer-Aided Design (CAD) software. In stage 804, a printing file can be generated for a printing plate of a plurality of picks to be printed. In embodiments, the 3D printer can print multiple picks in one run on a printing plate. The printing file lays out the plurality of pick designs to be printed. The 3D model can be imported into a slicer that converts the model into a series of thin layers and generates a G-code file containing instructions for the 3D printer.

In stage 806, the printing plate is attached to the printing device . . . . Conventional printing plates may be used that provide a bottom side of the picks that have 100% smooth or 100% textured surfaces. In embodiments, in order to provide a smooth surface of the playing portion that will better glide when hitting the strings, while providing a rougher texture at the top of the pick for a better grip, the printing file may be programmed to correspond with printing plates that consist of alternating smooth and textured sections (e.g., rows), so the plurality of picks is printed such that approximately ¼ to ¾ of the bottom side of the playing portion is smooth and the remaining portion of the bottom side is textured.

In stage 808, the plurality of picks can be printed on the printing plate. In embodiments, a printing material is selected and the printer is calibrated to ensure optimal printing conditions, e.g., leveling the print bed, setting the correct temperature for the print head and bed, etc. The printing file is uploaded to the 3D printer, and the printing process begins. The printer builds the object layer by layer, following the instructions in the printing file. Throughout the printing process, the printer may be monitored to ensure it is functioning correctly and to address any issues that arise, such as filament jams or layer.

In embodiments, the printing process can be a filament printing process. Moreover, parameters of the printing process can be set to improve the printing process of the picks. For example, the parameters of the printing process can be tuned to improve and increase the quality and wear resistance of the pick. By customizing the flow rate and line width of the fill, the thickness of each layer, the speed at which the layer prints, across both the inner and outer exterior walls, the adhesive and layer bonding of each layer of the pick is improved.

As used herein, line width is a width of a printed line of filament, in an x-direction or y-direction in a plane (e.g., layer) being printed. Line height is height in a z-direction of a line of filament. Flow rate is the amount of printing material being dispensed per unit of time, which can be controlled by pressure at the print heads. Printing speed is a liner speed of a print head in the x- direction or y-direction in the plane (e.g., layer) being printed.

In embodiments, the printing process can be controlled to print multiple custom line heights and widths within the pick which creates customized layers within the pick. For example, the heights can be printed to form height gradients within the pick and line width gradients within the pick. For instance, the printing process can be set to print thicker line heights and widths for the outer and inner walls (the exterior edge of the pick), thereby strengthening the edge of the pick. Likewise, for example, the printing process can be set to print different line heights and widths for different parts of the pick, e.g., top surface, bottom surface, inner and outer walls.

In embodiments, the flow rates can be controlled to improve the manufacture of the picks. For example, the printing process can utilize different flow rates for different filament types and different sections of the picks. For instance, the printing process can be set to the top layer slower so that the top surface of the pick has a glossy and/or smooth surface. The flow rate can impact the adhesion of each line of filament to each other. As such, the flow rate can be controlled to optimize adhesion and smooth surface thereby improving structural strength and protecting against wear, as well as providing a smoother quality audio tone during use.

In embodiments, various temperatures of the printing components can be controlled during the printing process. Temperature affects the flow properties of the materials being printed. The temperature of the components also affects the adhesion properties of the materials. In embodiments, the printing nozzles can be heated, for example, based on the material being used in the printing. For example, the temperature of the nozzle, printing plate, and/or chamber can be controlled to control the properties of the materials being printed, e.g., layer adhesion, surface finish, and shine. For instance, the temperature and speed of printing can be controlled to create a glossy or matte finish.

In embodiments, the printing plate and/or the chamber containing the printing plate can be heated during the manufacturing process. For example, the printing plate and/or a portion of the printing plate can be heated to a first temperature ranging between approximately 60 degrees Celsius and approximately 120 degrees. Likewise, a chamber containing the printing plate can be heated to a second temperature ranging between 60 degrees Celsius and approximately 80 degrees Celsius while printing the plurality of picks. The determination to heat the chamber and the temperature at which the chamber is heated can be based on the type of material being used to print the guitar picks. For example, chamber heating can be used when printing with high-temperature filaments, e.g., Delrin, Ultim, etc. The heating of the chamber allows the picks to cool at a controlled and consistent rate, thereby preventing warping in the pick if the materials cool rapidly.

In embodiments, the direction of printing relative to the orientation of each pick printed can be controlled to improve the performance of the picks. For example, the printing process can be set such that the infill lines are perpendicular to the playing portion of the pick, e.g., the lines are printed moving from the playing portion to the gripping portion. As such, the gaps between lines don't create friction when strumming thereby producing an improved playing portion, e.g., tip, for smooth strumming.

In embodiments, the printing process can be used to print logos or other designs/text (“graphics”) on portions of the pick. In embodiments, a logo creation design can be created as a separate 3D file that prints on top and/or within a top surface and/or bottom surface of the pick. For example, the 3D design file for the pick can include a recess designed for the logo and the logo 3D file fits within the recess on top of the pick. During printing, the picks are printed with one or more recesses in a surface of the pick (e.g., the top surface and/or the back surface). Then, the one or more recesses are filled the at least one recess with one or more layers to form the graphics. In some embodiments, the graphics can be substantially flat with a plane on the surface of the pick or raised above the plane of the surface of the pick. In embodiments, the layers that fill the one or more recesses can be different colors to create the effect of the graphic. For example, the logo can be a second layer (different color) added on top of the pick. In some embodiments, the second layer can be embossed (flat) or sometimes the logo be printed with a raised edge. In one example, the logo 3D file can be created to print flames on a surface of the pick. To produce the flames, imperceptible surfaces can be printed on the surface at different heights to get a four-color flame effect.

In stage 810, the plurality of printed picks can be dried and cured. In stage 812, a portion of the printed prick can be sanded. In embodiments, the playing portion of the top surface of the picks can be sanded. For example, a playing portion of approximately 10-15 mm can be sanded. When the picks are printed, the picks may have a residue on the front surface due to print and/or may have microscopic imperfections. The residue and/or imperfections can cause unwanted sounds, e.g., scratching noise, when the pick is used to play a stringed instrument. The sanding removes the residue and/or imperfections.

In some embodiments, the plurality of picks can be sanded by a person or an automated robotic sander. In some embodiments, the plurality of picks can be sanded using a sanding machine. In this embodiment, the sanding machine can be configured with sanding elements that match the pick locations in the printing plate, e.g., the bottom portions of the picks. The sanding machine can be engaged with the printing plate to sand the plurality of picks in one contact. While on plate (or off), sand the top surface of the pick, not including the fin. For example, the playing portion of the pick, which interacts with the strings of an instrument can be sanded. e.g., 10-15 mm. In the process described above, the printing can be performed using filament printing.

It shall be appreciated that the disclosed device and system can have multiple configurations in different embodiments. It shall be appreciated that the device and system described herein may comprise any alternative known materials in the field and be of any color, size, and/or dimensions.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D.

Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method of manufacturing a pick, the method comprising:
determining a printing file, the printing file including a layout for printing a plurality of picks on a printing plate; and
printing the plurality of picks on the printing plate, wherein the printing plate includes textured sections and the layout of the printing file causes a top portion of each pick of the plurality of picks to be printed on one of the textured sections.

2. The method of claim 1, the method further comprising one or more of the following:
heating a portion of the printing plate to a first temperature ranging between approximately 60 degrees Celsius and approximately 120 degrees; and
heating a chamber containing the printing plate to a second temperature ranging between 60 degrees Celsius and approximately 80 degrees Celsius while printing the plurality of picks.

3. The method of claim 1, the method further comprising one or more of the following:
depositing a plurality of filament lines, wherein one or more of the plurality of filament lines varies in at least one of height or width in predetermined portions of the plurality of picks;
depositing the plurality of filament lines at a flow rate and print speed, wherein at least one of flow rate and print speed varies in predetermined portions of the plurality of picks;
printing at least one graphic on a surface of the pick, comprising: printing each of the plurality of picks to include at least one recess in the surface of the pick, and filling the at least one recess with one or more layers to form the at least one graphic, wherein at least one graphic is substantially flat with a plane the surface of the pick or raised above the plane of the surface of the pick; and
sanding a playing portion of each of the plurality of picks after printing.

4. A method of manufacturing a pick, the method comprising:
determining a printing file, the printing file including a layout for printing a plurality of picks on a printing plate; and
printing the plurality of picks on the printing plate, wherein printing the plurality of picks on the printing plate comprises:
depositing a plurality of filament lines, wherein one or more of the plurality of filament lines varies in at least one of height or width in predetermined portions of the plurality of picks.

5. The method of claim 4, the method further comprising one or more of the following:
heating a portion of the printing plate to a first temperature ranging between approximately 60 degrees Celsius and approximately 120 degrees; and
heating a chamber containing the printing plate to a second temperature ranging between 60 degrees Celsius and approximately 80 degrees Celsius while printing the plurality of picks.

6. The method of claim 4, the method further comprising one or more of the following:
depositing a plurality of filament lines at a flow rate and print speed, wherein at least one of flow rate and print speed varies in predetermined portions of the plurality of picks;
printing at least one graphic on a surface of the pick, comprising: printing each of the plurality of picks to include at least one recess in the surface of the pick, and filling the at least one recess with one or more layers to form the at least one graphic, wherein at least one graphic is substantially flat with a plane the surface of the pick or raised above the plane of the surface of the pick; and
sanding a playing portion of each of the plurality of picks after printing.

7. The method of claim 4, wherein the printing plate includes textured sections and the layout of the printing file causes a top portion of each pick of the plurality of picks to be printed on one of the textured sections.

8. A method of manufacturing a pick, the method comprising:
determining a printing file, the printing file including a layout for printing a plurality of picks on a printing plate; and
printing the plurality of picks on the printing plate, wherein printing the plurality of picks on the printing plate comprises:
depositing a plurality of filament lines at a flow rate and print speed, wherein at least one of flow rate and print speed varies in predetermined portions of the plurality of picks.

9. The method of claim 8, the method further comprising one or more of the following:
heating a portion of the printing plate to a first temperature ranging between approximately 60 degrees Celsius and approximately 120 degrees; and
heating a chamber containing the printing plate to a second temperature ranging between 60 degrees Celsius and approximately 80 degrees Celsius while printing the plurality of picks.

10. The method of claim 8, the method further comprising one or more of the following:
depositing a plurality of filament lines, wherein one or more of the plurality of filament lines varies in at least one of height or width in predetermined portions of the plurality of picks;
printing at least one graphic on a surface of the pick, comprising: printing each of the plurality of picks to include at least one recess in the surface of the pick, and filling the at least one recess with one or more layers to form the at least one graphic, wherein at least one graphic is substantially flat with a plane the surface of the pick or raised above the plane of the surface of the pick; and
sanding a playing portion of each of the plurality of picks after printing.

11. The method of claim 8, wherein the printing plate includes textured sections and the layout of the printing file causes a top portion of each pick of the plurality of picks to be printed on one of the textured sections.

12. A method of manufacturing a pick, the method comprising:
determining a printing file, the printing file including a layout for printing a plurality of picks on a printing plate; and
printing the plurality of picks on the printing plate, wherein printing the plurality of picks on the printing plate comprises:
printing each of the plurality of picks to include at least one recess in a surface of the pick, and
filling the at least one recess with one or more layers to form at least one graphic, wherein at least one graphic is substantially flat with a plane the surface of the pick or raised above the plane of the surface of the pick.

13. The method of claim 12, the method further comprising one or more of the following:
heating a portion of the printing plate to a first temperature ranging between approximately 60 degrees Celsius and approximately 120 degrees;
heating a chamber containing the printing plate to a second temperature ranging between 60 degrees Celsius and approximately 80 degrees Celsius while printing the plurality of picks;
depositing a plurality of filament lines, wherein one or more of the plurality of filament lines varies in at least one of height or width in predetermined portions of the plurality of picks;
depositing the plurality of filament lines at a flow rate and print speed, wherein at least one of flow rate and print speed varies in predetermined portions of the plurality of picks; and
sanding a playing portion of each of the plurality of picks after printing.

14. The method of claim 12, wherein the printing plate includes textured sections and the layout of the printing file causes a top portion of each pick of the plurality of picks to be printed on one of the textured sections.

15. A method of manufacturing a pick, the method comprising:
determining a printing file, the printing file including a layout for printing a plurality of picks on a printing plate;
printing the plurality of picks on the printing plate; and
sanding a playing portion of each of the plurality of picks after printing.

16. The method of claim 15, the method further comprising one or more of the following:
heating a portion of the printing plate to a first temperature ranging between approximately 60 degrees Celsius and approximately 120 degrees;
heating a chamber containing the printing plate to a second temperature ranging between 60 degrees Celsius and approximately 80 degrees Celsius while printing the plurality of picks;
depositing a plurality of filament lines, wherein one or more of the plurality of filament lines varies in at least one of height or width in predetermined portions of the plurality of picks;
depositing the plurality of filament lines at a flow rate and print speed, wherein at least one of flow rate and print speed varies in predetermined portions of the plurality of picks; and
printing at least one graphic on a surface of the pick, comprising: printing each of the plurality of picks to include at least one recess in the surface of the pick, and filling the at least one recess with one or more layers to form the at least one graphic, wherein at least one graphic is substantially flat with a plane the surface of the pick or raised above the plane of the surface of the pick.

17. The method of claim 15, wherein the printing plate includes textured sections and the layout of the printing file causes a top portion of each pick of the plurality of picks to be printed on one of the textured sections.

18. A method of manufacturing a pick, the method comprising:
determining a printing file, the printing file including a layout for printing a plurality of picks on a printing plate;
heating at least one of:
a portion of the printing plate to a first temperature ranging between approximately 60 degrees Celsius and approximately 120 degrees, and
heating a chamber containing the printing plate to a second temperature ranging between 60 degrees Celsius and approximately 80 degrees Celsius while printing the plurality of picks; and
printing the plurality of picks on the printing plate.

19. The method of claim 18, the method further comprising one or more of the following:
depositing a plurality of filament lines, wherein one or more of the plurality of filament lines varies in at least one of height or width in predetermined portions of the plurality of picks;
depositing the plurality of filament lines at a flow rate and print speed, wherein at least one of flow rate and print speed varies in predetermined portions of the plurality of picks;
printing at least one graphic on a surface of the pick, comprising: printing each of the plurality of picks to include at least one recess in the surface of the pick, and filling the at least one recess with one or more layers to form the at least one graphic, wherein at least one graphic is substantially flat with a plane the surface of the pick or raised above the plane of the surface of the pick; and
sanding a playing portion of each of the plurality of picks after printing.

20. The method of claim 18, wherein the printing plate includes textured sections and the layout of the printing file causes a top portion of each pick of the plurality of picks to be printed on one of the textured sections.
